(19) United States
(12) Patent Application Publication
(10) Pub. No.: US 2007/0044080 A1
(43) Pub. Date: Feb. 22, 2007

(54) Structure initializers and complex assignment

(75) Inventors: Paul A. Vick, Seattle, WA (US); Henricus Johannes Maria Meijer, Mercer Island, WA (US); Amanda Silver, Seattle, WA (US); Chris A. Suver, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/208,703

(22) Filed: Aug. 22, 2005

(51) Int. Cl. G06F 9/45; G06F 9/44

(52) U.S. Cl. 717/143; 717/116

(57) ABSTRACT

The claimed subject matter provides a system and/or a method that facilitates constructing and initializing an object within a single expression. An interface component can receive data related to an object that has at least one property associated therewith. A syntax component can combine a construction of the object and an initialization of the at least one property into a single expression.

### BACKGROUND

The advent of global communications networks (e.g., the Internet) now makes accessible an enormous amount of data. People access and query unstructured and structured data every day. Unstructured data is used for creating, storing and retrieving reports, e-mails, spreadsheets and other types of documents, and consists of any data stored in an unstructured format at an atomic level. In other words, in the unstructured content, there is no conceptual definition and no data type definition—in textual documents, a word is simply a word. Current technologies used for content searches on unstructured data require tagging entities such as names or applying keywords and metatags. Therefore, human intervention is required to help make the unstructured data machine readable. Structured data is any data that has an enforced composition to the atomic data types. Structured data is managed by technology that allows for querying and reporting against predetermined data types and understood relationships.

Programming languages continue to evolve to facilitate specification by programmers as well as efficient execution in relation to unstructured data and/or structured data. In the early days of computer languages, low-level machine code was prevalent. With machine code, a computer program or instructions comprising a computer program were written with machine languages or assembly languages and executed by the hardware (e.g., microprocessor). These languages provided an efficient means to control computing hardware, but were very difficult for programmers to comprehend and develop sophisticated logic. Subsequently, languages were introduced that provided various layers of abstraction. Accordingly, programmers could write programs at a higher level with a higher-level source language, which could then be converted via a compiler or interpreter to the lower level machine language understood by the hardware. Further advances in programming have provided additional layers of abstraction to allow more advanced programming logic to be specified much quicker then ever before. However, these advances do not come without a processing cost.

Compilers and/or interpreters bear the burden of translating high-level logic into executable machine code. In general, a compilers and/or interpreters are components that receive a program specified in a source programming language (e.g., C, C#, Visual Basic, Java . . . ) and covert the logic provided thereby to machine language that is executable by a hardware device. However, the conversion need not be done verbatim. In fact, conventional compilers and/or interpreters analyze the source code and generate very efficient code. For example, programmers write code that sets forth a logical flow of operations that is intuitive and easy for humans to understand, but is often inefficient for a computer to execute. Compilers and/or interpreters can identify inefficiencies and improve program performance at the hardware level by eliminating unnecessary operations and/or rearranging the execution of instructions while still achieving the intended results. In this manner, programmers can create robust and efficient software programs.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate combining a construction of an object and an initialization of at least one property into a single expression. A syntax component can utilize a single expression that represents the construction of an object and the initialization of a property and/or field associated therewith. The syntax component can receive data via an interface component, wherein the data can be related to a programming language including at least one object and at least one property and/or field. By combining the construction and initialization of the object into a single expression, the syntax component facilitates utilizing a programming language.

In accordance with one aspect of the claimed subject matter, the syntax component further utilizes the single expression in conjunction with an object type collection. The syntax component can implement a collection component that that allows the single expression to construct and initialize the object, wherein the object implements an interface and the property is added to a collection. Moreover, the type can implement any suitable interface and/or if the type exposes a certain patter, the elements can be added to the collection through successive calls utilizing the single expression.

In accordance with another aspect of the claimed subject matter, the syntax component further includes a nested component. The nested component allows the single expression to be nested within the data to allow for complicated object instances with this single expression. In other words, the syntax statement itself can be nested, wherein the field you are initializing is an object or collection itself and the nested component can create an instance and initialize that instance of the type of the field at the substantially similar time.

In accordance with another aspect of the innovation described herein, the syntax component can further include a projection component that infers an identifier (e.g., object instance) to be assigned. In other words, the projection component allows an identifier related to the object to be constructed and initialized. Moreover, the syntax component can include an expression component that allows an invocation expression to be utilized in conjunction with the single expression.

In accordance with another aspect of the innovation described herein, the syntax component can utilize a late binding technique. The syntax can further include a typeless component allows the omission of a new keyword and a type that is being constructed and initialized, wherein the new keyword and type is inferred. In addition, the syntax component can include an anonymous component that provides the object that is an anonymous type to be inferred in relation to the single expression. Furthermore, the syntax component can also include an ordinal component that utilizes an ordinal base and ordinal assignment in a collection based on an unidentified target type. In other aspects of the claimed subject matter, methods are provided that facilitate utilizing a single expression for the construction of an object and the initialization of a property and/or field associated therewith.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates combining a construction of an object and an initialization of at least one property into a single expression.

FIG. 2 illustrates a block diagram of an exemplary system that facilitates construction and initializing an object and at least one related property.

FIG. 3 illustrates a block diagram of an exemplary system that facilitates utilizing a combined expression in relation with a compiler.

FIG. 4 illustrates a block diagram of an exemplary system that facilitates utilizing a combined expression that is nested and/or related to a collection.

FIG. 5 illustrates a block diagram of an exemplary system that facilitates utilizing a combined expression.

FIG. 6 illustrates a block diagram of an exemplary system that facilitates utilizing a combined expression in relation to at least one of typeless structure, a late binding, an ordinal, and an inference.

FIG. 7 illustrates an exemplary methodology for combining a construction of an object and an initialization of at least one property into a single expression.

FIG. 8 illustrates an exemplary methodology that facilitates combining a construction of an object and an initialization of at least one property into a single expression.

FIG. 9 is a schematic block diagram of a compilation environment.

FIG. 10 illustrates an exemplary networking environment, wherein the novel aspects of the claimed subject matter can be employed.

FIG. 11 illustrates an exemplary operating environment that can be employed in accordance with the claimed subject matter.

### DETAILED DESCRIPTION

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

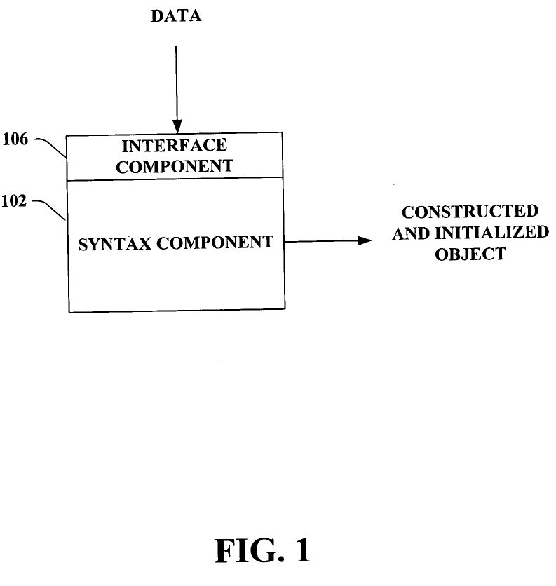

Now turning to the figures, FIG. 1 illustrates a system 100 that facilitates combining a construction of an object and an initialization of at least one property into a single expression. A syntax component 102 can receive data via an interface component 106, wherein the data can be combined into a single expression including at least a construction of an object and an initialization of at least one property and/or field associated therewith. The data received can be, but is not limited to, any suitable programming language that includes at least one object to be constructed and/or initialized. The syntax component 102 can facilitate constructing and/or initializing objects and/or properties related to data received via the interface component 106. It is to be appreciated that the syntax component 102 can initialize the object based at least on a field and/or property of a type and elements of a collection (discussed infra).

For instance, the conventional technique for constructing an object and initializing at least one property and/or field associated therewith entailed a tedious and monotonous technique. A user and/or developer would have to create an object instance by calling a constructor function and then recursively assigning object instanced to nested objects. In other words, a user and/or developer would have to construct an object and then utilize a series of statements to assign values to the object's properties and/or fields. Yet, the syntax component 102 allows such construction and initialization to be incorporated into a single expression eliminating the requirements of tedious and monotonous expressions or statements that provide construction or initialization only.

In one example, a user and/or developer can utilize a conventional technique of tedious coding to construct an object and recursively assigning object instances as depicted below. It is to be appreciated that the following is one example and is not to be seen as limiting on the claimed subject matter.

```
Structure Customer
    Name As String
    Address As Address
    Age As Integer
End Structure
Structure Address
    Street As String
    City As String
    State As String
    ZIP As String
End Structure
Module Test
  Sub Main( )
    End With
    Dim c As New Customer( )
    With c
        .Name := “John Smith”,
        Dim a As Address
    With a
        .Street := “23 Main St.”
        .City := “Peoria”
        .State := “IL”
        .ZIP := “13934”
    End With
    .Address := a
    .Age := 34
    End With
  End Sub
End Module
```

As seen above, in every construction of an object, a recursive assigning of the object instances to the nested object must be done. Thus, the objects “Customer” and “Address” are constructed in one expression and then properties and/or fields associated therewith are initialized in a disparate statement. This conventional style of object creation can be extremely tedious based at least in part upon the user and/or developer to explicitly define imperative statements to build a complex object instance.

The syntax component 102 alleviates the necessity of utilizing two separate expressions by allowing the user and/or developer to combine the construction and the assignment of values to properties and/or fields within such objects into a single expression. Following the above example, the syntax component 102 allows the construction of “Customer” and initialization of “Name” and “Address” in a single statement. Thus, the fields and/or properties associated with “Customer” can be initialized in a single expression that includes the construction of such object.

The syntax component 102 can utilize a structure initializer to initialize any type by listing the values and/or properties to assign to the public properties and/or elements of a type. The following example depicts the syntax component 102 providing a single expression for construction of an object and property and/or field value assignment. It is to be appreciated and understood that the following is an example and the claimed subject matter is not limited to the illustrated pseudo code. Moreover, the type of variable that is to be initialized can have a parameterless constructor in order to prevent a compile-time error.

```
Structure Customer
    Public Name As String
    Public Phone As String
End Structure
Module Test
  Sub Main( )
  Dim c As Customer
  c = new Customer { Name := “John Smith”,
  Phone := “(206) 555-1212” }
  End Sub
End Module
REM Alternate syntax
Module Test
  Sub Main( )
  Dim c As Customer
  c = new Customer { .Name = “John Smith”,
  .Phone = “(206) 555-1212” }
  End Sub
End Module
```

Moreover, the system 100 can include any suitable and/or necessary interface component 106, which provides various adapters, connectors, channels, communication paths, etc. to integrate the syntax component 102 into virtually any operating and/or database system(s). In addition, the interface component 106 can provide various adapters, connectors, channels, communication paths, etc., that provide for interaction with the syntax component 102 and data.

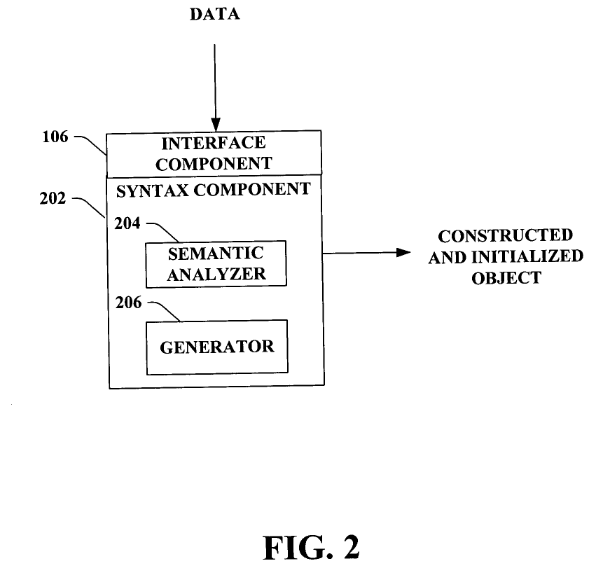

FIG. 2 illustrates a system 200 that facilitates construction and initializing an object and at least one related property. A syntax component 202 can receive data via the interface component 106, wherein the data can be combined into a single expression including a construction of an object and an initialization of at least one property and/or field associated therewith. The data received can be, but is not limited to, any suitable programming language that includes at least one object to be constructed and/or initialized. The syntax component 202 can combine the object construction and value assignment for a property and/or field associated therewith into a single expression to facilitate programming for a user and/or developer. In other words, the syntax component 202 can provide a constructed and initialized object from a single expression. It is to be appreciated that the syntax component 202 and data can be substantially similar to the syntax component 102 as described in FIG. 1.

The syntax component 202 can include a semantic analyzer 204 that can evaluate the date received via the interface component 106. The semantic analyzer 204 can analyze any data received to facilitate creating a single expression that combines the construction of an object and value assignment to a property and/or field related thereto. For instance, the semantic analyzer 204 can evaluate, but is not limited to evaluating, the type of data, type of programming language, number of objects, at least one property, at least one field, a property and/or field associated to an object, a property and/or a field associated to a plurality of objects, etc. It is to be appreciated that although the semantic analyzer 204 is depicted as being incorporated into the syntax component 202, it can be a stand alone component, incorporated into the syntax component 202, and/or any combination thereof.

The syntax component 202 can further include a generator 206 that can generate a single expression to construct an object and initialize a property and/or field associated to such object based at least in part upon the semantic analyzer 204. For example, data can be received, wherein the semantic analyzer 204 can determine a number of objects constructed and at least one property and/or field associated therewith. The generator 206 can generate a single expression to incorporate the construction of the object and assign values to the property and/or field related thereto. It is to be appreciated that although the generator 206 is depicted as being incorporated into the syntax component 202, it can be a stand alone component, incorporated into the syntax component 202, and/or any combination thereof.

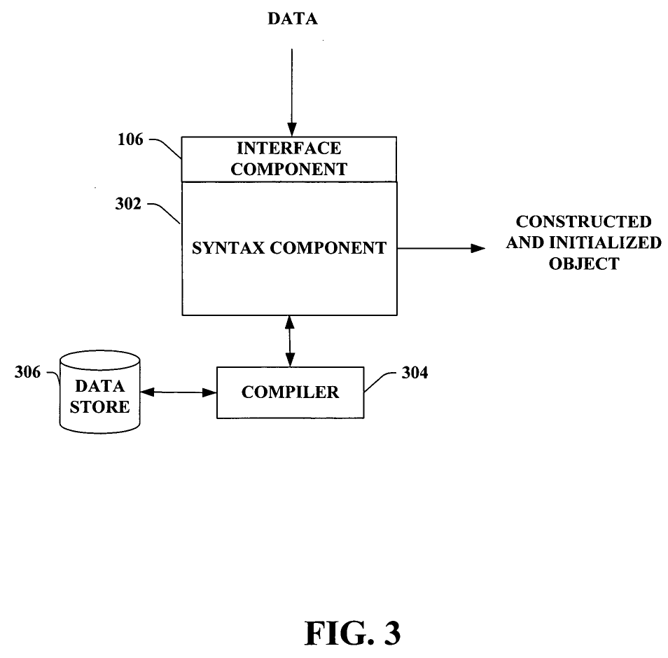

FIG. 3 illustrates a system 300 that facilitates utilizing a combined expression in relation with a compiler. A syntax component 302 can combine data received into a single expression including at least a construction of an object and an initialization of at least one property and/or field associated therewith. The data received can be, but is not limited to, any suitable programming language that includes at least one object to be constructed and/or initialized. The syntax component 302 can facilitate constructing and/or initializing objects and/or properties related to data received via the interface component 106. It is to be appreciated that the syntax component 302 can initialize the object based at least on a field and/or property of a type and elements of a collection (discussed infra).

Moreover, the syntax component 302 can utilize a compiler 304 to facilitate implementing a combined expression that contains object constructions and initialization of a property and/or field associated to the type. The compiler 304 (described in further detail infra) can receive data (e.g., the programmatic source code from the interface component 106) and generate computer executable program or alternatively some intermediate format (e.g., IL (intermediate language)) that can be further compiled at runtime, for example by a just-in-time (JIT) compiler. The compiler 304 could also be a part of an IDE.

The syntax component 302 can utilize a data store 308, wherein the data store 308 can store various data related to the system 300. The data store 308 can provide storage for computer programmable code, pseudo code, object references, property and/or field references, compiler 304 instructions, etc. The data store 308 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 308 of the subject systems and methods is intended to comprise, without being limited to, these and any other suitable types of memory. In addition, it is to be appreciated that the data store 308 can be a server, a database, a hard drive, and the like.

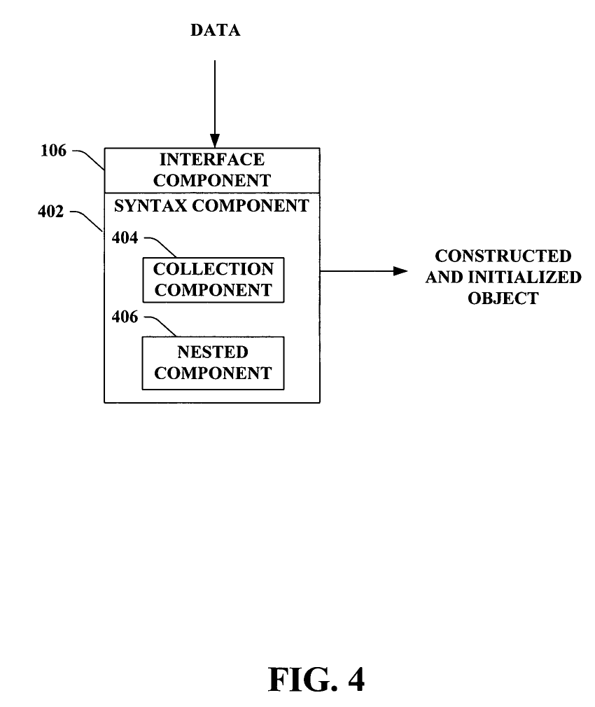

FIG. 4 illustrates a system 400 that facilitates utilizing a combined expression that is nested and/or related to a collection. A syntax component 402 can receive data related to a programming language, wherein the syntax component 402 can provide a single expression to represent the construction of an object and the initialization of a property and/or field related to such object. In other words, the single expression provides an efficient and convenient technique to construct an object and assign values to properties and/or fields related to the object. It is to be appreciated and understood that the syntax component 402 can be substantially similar to the components described in previous figures.

The syntax component 402 can provide a single expression that includes construction of an object and the initialization of a property and/or field related thereto. In one instance, the object can be a type that contains a parametrized property, wherein each property can be initialized independently by specifying the values to assign to the particular properties at a given index. For instance, the following pseudo code is an example that illustrates the type including parametrized properties.

```
Structure Person
    Name As String
    Phones(10) As String
End Structure
Structure Year
    Property Month(Name As String) As Integer
    ...
    End Property
End Year
Module Test
  Sub Main( )
  Dim P As Person
  Dim Y As Year
  P = New Person { Name := “john”, Phones(3) := “cellphone”,
  Phones(1) := “homephone” }
  Y = New Year { Month(“January”) := 1, Month(“February”) := 2, ... }
  End Sub
End Module
REM Alternate syntax
Module Test
  Sub Main( )
  Dim P As Person
  Dim Y As Year
  P = New Person { .Name = “john”, .Phones(3) = “cellphone”,
  .Phones(1) = “homephone” }
  Y = New Year { .Month(“January”) = 1, .Month(“February”) = 2, ... }
  End Sub
End Module
```

It is to be appreciated that in the above example, the type of the initializer element can be convertible to the type of the collection element and/or instance member that it is being assign to, otherwise a compile-time error results. Moreover, for indexed properties the types of the property arguments can be convertible to the property parameters.

The syntax component 402 can include a collection component 404 that can leverage existing syntax related to a collection. For instance, if the type implements an interface (not to be confused with the interface component 106) and/or a certain pattern, wherein the interface can be System.Collections.Generic.ICollection(Of T), or System.Collections.IList, or if the type exposes a single parameter Add method, the elements cannot be named. In other words, each of the elements can be added to the collection through successive calls to the Add method of the interface. For instance, the following pseudo code can be an example:

```
Module Test
  Sub Main( )
    Dim x( ) As Integer
    Dim c As List(Of Integer)
    x = New Integer( ) {1, 2, 3}
    c = New List(Of Integer) {1, 2, 3}
  End Sub
End Module
```

The collection can be implemented with any interface and satisfies a certain pattern and/or Add method that allows you to assign elements in the collection. It is to be appreciated that the collection can be any suitable interface. Collection component 404 can allow the construction of any type that that is a collection and allows an initialization of the various elements of that collection. It is to be appreciated that the two types of initialization can be 1) fields and/or properties of a type; and 2) elements of the collection.

The syntax component 402 can further include a nested component 406 that allows the single expression (e.g., that combines object construction and initialization of a property and/or field associated thereto) to be nested. The following pseudo code is an example of utilizing a nested single expression that combines the construction of an object and the initialization of a property and/or field associated therewith. It is to be appreciated that the following is an example and the claimed subject matter is not so limited.

```
Structure Customer
    Name As String
    Address As Address
    Age As Integer
End Structure
Structure Address
    Street As String
    City As String
    State As String
    ZIP As String
End Structure
Module Test
  Sub Main( )
  Dim c As Customer
  c = New Customer _{—}
  { Name := “John Smith”, _{—}
  Address := New Address {Street := “23 Main St.”, City :=
  “Peoria”, State := “IL”, ZIP := “13934”}, _{—}
  Age := 34
  }
  End Sub
End Module
Module Test
  Sub Main( )
  Dim c As Customer
  c = New Customer _{—}
  { .Name = “John Smith”, _{—}
  .Address = New Address { .Street = “23 Main St.”, .City =
  “Peoria”, .State = “IL”, .ZIP = “13934”}, _{—}
  .Age = 34
  }
  End Sub
End Module
```

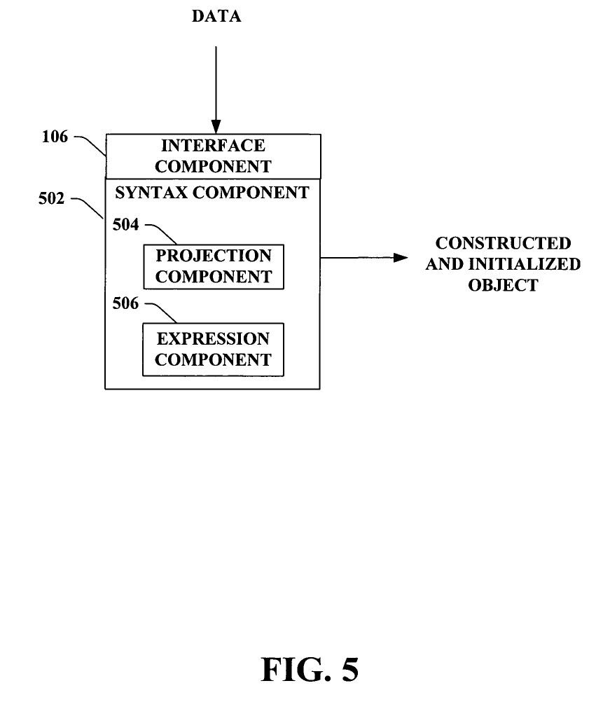

FIG. 5 illustrates a system 500 that facilitates utilizing a combined expression. A syntax component 502 can receive data related to a programming language, wherein the syntax component 502 can provide a single expression to represent the construction of an object and the initialization of a property and/or field related to such object. In other words, the single expression provides an efficient and convenient technique to construct an object and assign values to properties and/or fields related to the object. It is to be appreciated and understood that the syntax component 502 can be substantially similar to the components described in previous figures.

The syntax component 502 can include a projection component 504 that infers an identifier (e.g., object instance) to be assigned. The following pseudo code is an example of such inference related to the identifier to assign. It is to be appreciated that the following is an example and the claimed subject matter is not so limited. For example New Point{OtherPoint.X, OtherPoint.Y} can be a shorthand for new Point{X:=OtherPoint.X, Y:=OtherPoint.Y}.

The syntax component 502 can also include an expression component 506 that allows an invocation expression to be utilized in conjunction with the single expression that combines object construction and property and/or field initialization. The following pseudo code is an example of the expression component 506 that utilizes an invocation expression in relation to the single expression. It is to be appreciated that the following is an example and the claimed subject matter is not so limited.

```
SimpleExpression ::=
    LiteralExpression
    ParenthesizedExpression
    InstanceExpression
    SimpleNameExpression
    AddressOfExpression
    StructureInitializerExpression
StructureInitializerExpression ::= { StructureElementList }
StructureElementList ::=
    StructureElement
    StructureElementList , StructureElement
StructureElement ::=
  [ InvocationExpression := ] Expression
  MemberAccessExpression
  SimpleExpression
ObjectCreationExpression ::=
    New NonArrayTypeName [ ( [ ArgumentList ] ) ]
    New NonArrayTypeName StructureInitializerExpression
ArrayCreationExpression ::=
    New NonArrayTypeName ArraySizeInitializationModifier
StructureInitializerExpression
VariableDeclarator ::=
    VariableIdentifiers [ As [ New ] TypeName [ ( ArgumentList ) ]
]
VariableIdentifier [ As TypeName ] [ = Expression ]
```

It is also to be appreciated that the VariableInitializer, RegularInitializer, VariableInitializerLst, VariableInitializer, and ArrayElementInitializer productions can be an option. Moreover, there is alternative syntax in relation to the StructureElement such as, but not limited to, the following:

```
StructureElement ::=
    [ .IdentifierOrKeyword [([ArgumentList])] := ] Expression
    MemberAccessExpression
    SimpleExpression
```

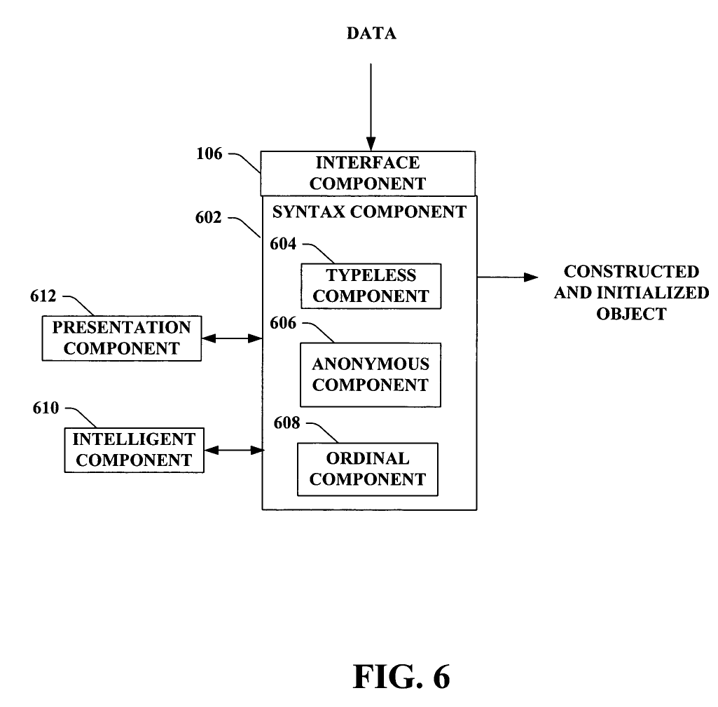

FIG. 6 illustrates a system 600 that facilitates utilizing a combined expression in relation to at least one of typeless structure, a late binding, an ordinal, and an inference. A syntax component 602 can utilize a single expression to construct and initialize an object of any type, wherein the initialization can be the assignment of a property and/or field associated therewith. The syntax component 602 can utilize a late binding technique such that the object that is constructed need not have a reference. In other words, the syntax component 602 can omit the new keyword and the type that is being initialized. In such a situation, the syntax component 602 can represent a value of whatever type the expression is converted. It is to be appreciated that the syntax component 602 in this situation can be utilized in assignment statements or as part of a parameter list where the type destination is known.

The syntax component 602 can include a typeless component 604 that allows the omission of the new keyword and the type that is being initialized. In other words, the object being constructed and initialized in a single expression need not be included in the data received by the interface component 106. The following is pseudo code that implements the typeless structure technique and it is to be appreciated that the claimed subject matter is not so limited.

```
Module Test
  Sub Main( )
  Dim c As Customer
  c = { Name := “John Smith”, _{—}
    Address := { Street := “23 Main St.”, City := “Peoria”, State := “IL”,
ZIP := “13934”}, _{—}
    Age := 34, _{—}
    }
  End Sub
End Module
REM Alternate syntax
Module Test
  Sub Main( )
  Dim c As Customer
  c = { .Name = “John Smith”, _{—}
    .Address = { .Street = “23 Main St.”, .City = “Peoria”, .State = “IL”,
.ZIP = “13934”}, _{—}
    .Age = 34, _{—}
    }
  End Sub
End Module
```

The syntax component 602 can include an anonymous component 606 that allows an anonymous type to be inferred in relation to the single expression providing the construction of the object and initialization (e.g., value assignment) to a property and/or field associated therewith. The anonymous component 606 allows the type to be of an unidentified type and/or any type which can be comparable to a wild card type that can be later defined and/or inferred upon compilation. Thus, a user and/or developer need not define the type within the single expression (e.g., providing the construction of any type object and the initialization of a property and/or field associated therewith) since the compiler can infer the anonymous type at compilation.

The syntax component 602 can also include an ordinal component 608 that utilizes an ordinal based technique when the target type cannot be inferred. In other words, when the identifiers for the structure (e.g., a single expression including object construction and property and/or field initialization) of the target type cannot be inferred (e.g., due to projection style initialization utilizing indexed accessors to get values from a collection or by virtue of containing differently typed nested literals) the inferred type structure is assumed to be ordinal based and items in the collections can be assigned by their ordinal location. It is to be appreciated that this can apply for typeless variables. The following pseudo code illustrates two examples of utilizing the ordinal based technique and the claimed subject matter is not so limited.

```
    Module Test
      Sub Main( )
      Dim col As New Collection
      col(0) = 10
      col(1) = 20
      Dim c = { col(0), col(1) }
      col(3) = c(0)  ‘col(3) = 10
      End Sub
    End Module
And:
    Module Test
      Sub Main( )
      Dim c = { 10, { 20, 30 } }
      Dim i As Integer = c(1)(1)  ‘i = 30
      End Sub
    End Module
```

The system 600 facilitates utilizing a single expression (e.g., that combines the construction of any object type and the initialization of at least one property and/or field related thereto) in relation to at least one of typeless structure, a late binding, an ordinal, and an inference. The system 600 can include a syntax component 602, a typeless component 604, and an ordinal component 606 that can all be substantially similar to respective components described above. The system 600 further includes an intelligent component 610. The intelligent component 610 can be utilized by the syntax component 602 to facilitate utilizing a single expression for construction of an object and initialization of a property and/or field associated therewith. For example, the intelligent component 610 can infer the object to which is being constructed, initialized, the field to assign a value, the property to assign a value, the type the single expression is relating to, etc.

It is to be understood that the intelligent component 610 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

A presentation component 612 can provide various types of user interfaces to facilitate interaction between a user and any component coupled to the syntax component 602. As depicted, the presentation component 612 is a separate entity that can be utilized with the syntax component 602. However, it is to be appreciated that the presentation component 612 and/or similar view components can be incorporated into the syntax component 602 and/or a stand-alone unit. The presentation component 612 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such vertical and/or horizontal scroll bars for navigation and toolbar buttons to determine whether a region will be viewable can be employed. For example, the user can interact with one or more of the components coupled to the syntax component 602.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

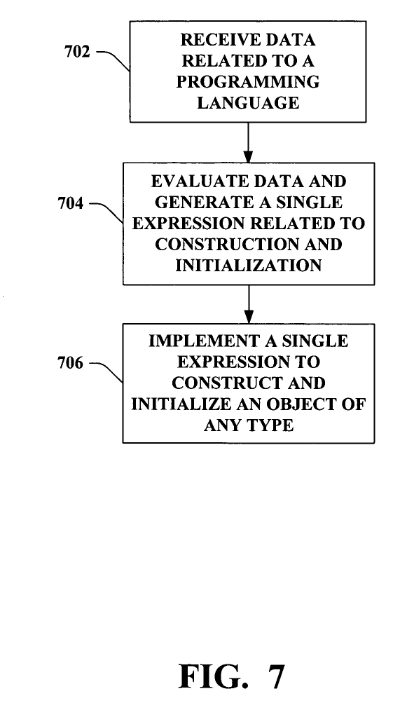

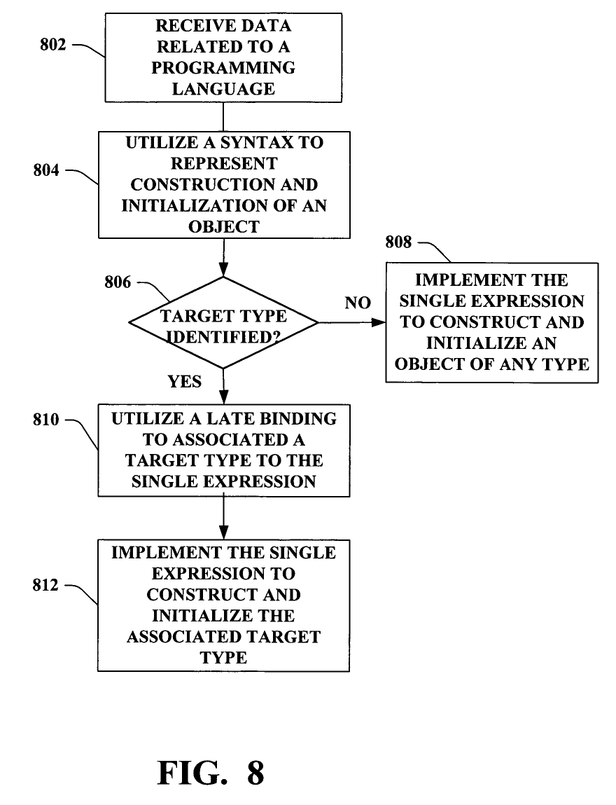

FIGS. 7-8 illustrate methodologies in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events.

FIG. 7 illustrates a methodology 700 for combining a construction of an object and an initialization of at least one property into a single expression. At reference numeral 702, data can be received related to a programming language. The data can include at least one object and at least one property and/or field associated therewith. At reference numeral 704, the data received is evaluated. For instance, the evaluation can include, but is not limited to, the type of data, type of programming language, number of objects, at least one property, at least one field, a property and/or field associated to an object, a property and/or a field associated to a plurality of objects, etc. Moreover, at reference numeral 704, a single expression can be generated to relate to the construction and initialization of any object related to data received. At reference numeral 706, a single expression is implemented to construct an object and initialize a property and/or field associated therewith.

FIG. 8 illustrates a methodology 800 that facilitates combining a construction of an object and an initialization of at least one property into a single expression. At reference numeral 802, data is received, wherein the data relates to a programming language and can be associated with at least one object including at least one property and/or field. At reference numeral 804, syntax can be utilized to represent the construction and initialization of an object. For example, a user and/or developer can utilize a syntax that includes a single expression for constructing and initializing any object type.

At reference numeral 806, an analysis is made as to whether the target type is identified. If the target type is identified, the method continues at reference numeral 808 where the single expression can be implemented to construct and initialize an object and assign values to properties and/or fields associated therewith. If the target type is not identified, at reference numeral 810, a late binding technique can be utilized to associate a target type to the single expression. In one example, a typeless (e.g., new keyword omitted) structure can evaluate the target type by representing a value of whatever type the single expression is converted to. It is to be appreciated that such typeless structure can be utilized in assignment statements or as part of a parameter list where the type destination is known. In another example, the unidentified target type can be inferred based at least in part upon the fields and/or properties associated therewith. In yet another example, an anonymous type can be implemented, wherein the unidentified type is an anonymous type that can be inferred at compilation. In another example, the unidentified target type may not be inferred and an ordinal base is assumed and items in the collection can be assigned by an ordinal location. By utilizing the above late binding techniques, the unidentified target type is identified. At reference numeral 812, the single expression to construct and initialize the associated target type is implemented.

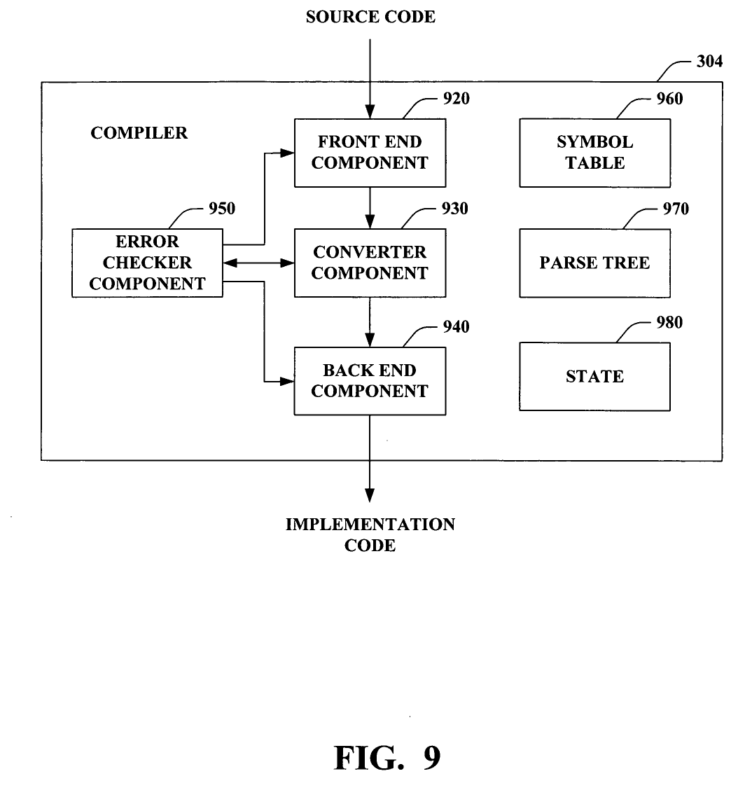

FIG. 9 is a block diagram depicting a compiler environment 900 that can be utilized to produce implementation code (e.g., executable, intermediate language . . . ). The compiler environment 900 includes a compiler 304 including front-end component 920, converter component 930, back-end component 940, error checker component 950, symbol table 960, parse tree 970, and state 980. The compiler 304 accepts source code as input and produces implementation code as output. The input can include but is not limited to delimited programmatic expressions or qualified identifier as described herein. The relationships amongst the components and modules of the compiler environment illustrate the main flow of data. Other components and relationships are not illustrated for the sake of clarity and simplicity. Depending on implementation, components can be added, omitted, split into multiple modules, combined with other modules, and/or other configurations of modules.

Compiler 304 can accept as input a file having source code associated with processing of a sequence of elements. The source code may include lambda expressions and associated functions, methods and/or other programmatic constructs. Compiler 304 may process source code in conjunction with one or more components for analyzing constructs and generating or injecting code.

A front-end component 920 reads and performs lexical analysis upon the source code. In essence, the front-end component 920 reads and translates a sequence of characters (e.g., alphanumeric) in the source code into syntactic elements or tokens, indicating constants, identifiers, operator symbols, keywords, and punctuation among other things.

Converter component 930 parses the tokens into an intermediate representation. For instance, the converter component 930 can check syntax and group tokens into expressions or other syntactic structures, which in turn coalesce into statement trees. Conceptually, these trees form a parse tree 970. Furthermore and as appropriate, the converter module 930 can place entries into a symbol table 930 that lists symbol names and type information used in the source code along with related characteristics.

A state 980 can be employed to track the progress of the compiler 304 in processing the received or retrieved source code and forming the parse tree 970. For example, different state values indicate that the compiler 304 is at the start of a class definition or functions, has just declared a class member, or has completed an expression. As the compiler progresses, it continually updates the state 980. The compiler 304 may partially or fully expose the state 980 to an outside entity, which can then provide input to the compiler 304.

Based upon constructs or other signals in the source code (or if the opportunity is otherwise recognized), the converter component 930 or another component can inject code corresponding to facilitate efficient and proper execution. Rules coded into the converter component 930 or other component indicates what must be done to implement the desired functionality and identify locations where the code is to be injected or where other operations are to be carried out. Injected code typically includes added statements, metadata, or other elements at one or more locations, but this term can also include changing, deleting, or otherwise modifying existing source code. Injected code can be stored as one or more templates or in some other form. In addition, it should be appreciated that symbol table manipulations and parse tree transformations can take place.

Based on the symbol table 960 and the parse tree 970, a back-end component 940 can translate the intermediate representation into output code. The back-end component 940 converts the intermediate representation into instructions executable in or by a target processor, into memory allocations for variables, and so forth. The output code can be executable by a real processor, but the invention also contemplates output code that is executable by a virtual processor.

Furthermore, the front-end component 920 and the back end component 940 can perform additional functions, such as code optimization, and can perform the described operations as a single phase or in multiple phases. Various other aspects of the components of compiler 304 are conventional in nature and can be substituted with components performing equivalent functions. Additionally, at various stages during processing of the source code, an error checker component 950 can check for errors such as errors in lexical structure, syntax errors, and even semantic errors. Upon detection error, checker component 950 can halt compilation and generate a message indicative of the error.

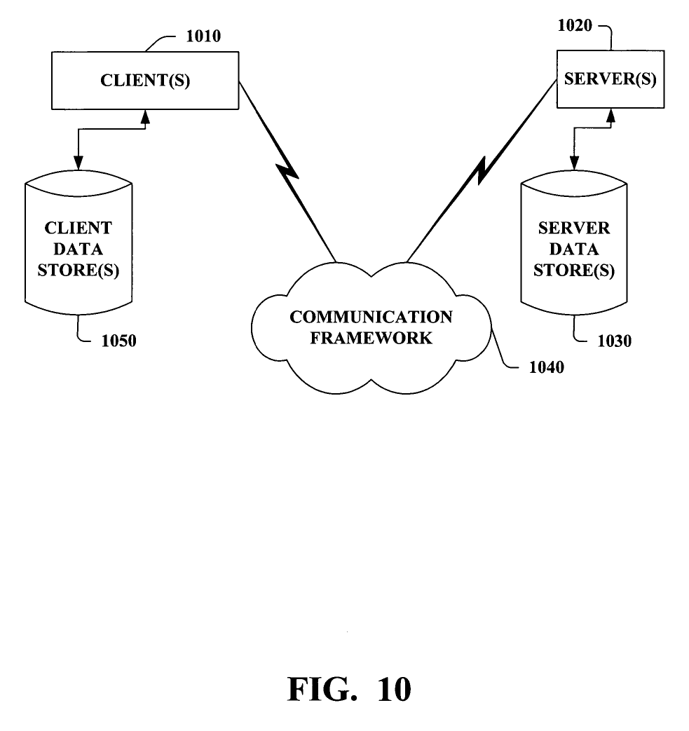

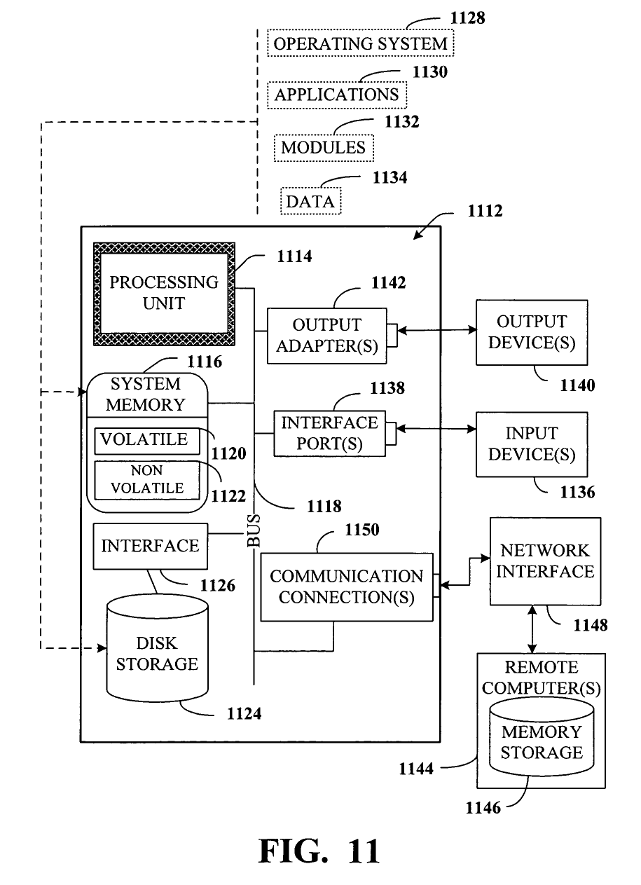

In order to provide additional context for implementing various aspects of the claimed subject matter, FIGS. 10-11 and the following discussion is intended to provide a brief, general description of a suitable computing environment in which the various aspects of the subject innovation may be implemented. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 10 is a schematic block diagram of a sample-computing environment 1000 with which the claimed subject matter can interact. The system 1000 includes one or more client(s) 1010. The client(s) 1010 can be hardware and/or software (e.g., threads, processes, computing devices). The system 1000 also includes one or more server(s) 1020. The server(s) 1020 can be hardware and/or software (e.g., threads, processes, computing devices). The servers 1020 can house threads to perform transformations by employing the subject innovation, for example.

One possible communication between a client 1010 and a server 1020 can be in the form of a data packet adapted to be transmitted between two or more computer processes. The system 1000 includes a communication framework 1040 that can be employed to facilitate communications between the client(s) 1010 and the server(s) 1020. The client(s) 1010 are operably connected to one or more client data store(s) 1050 that can be employed to store information local to the client(s) 1010. Similarly, the server(s) 1020 are operably connected to one or more server data store(s) 1030 that can be employed to store information local to the servers 1020.

With reference to FIG. 11, an exemplary environment 1100 for implementing various aspects of the claimed subject matter includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), or flash memory. Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 also includes removable/non-removable, volatile/non-volatile computer storage media. FIG. 11 illustrates, for example a disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in the suitable operating environment 1100. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that the claimed subject matter can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates constructing an object, comprising:
an interface component that receives data related to an object that has at least one of a property and a field associated therewith; and
a syntax component that combines a construction of the object and an initialization of the at least one of the property and the field into a single expression.

2. The system of claim 1, further comprising a semantic analyzer that analyzes data received to facilitate creating a single expression.

3. The system of claim 1, further comprising a generator that generates the single expression.

4. The system of claim 1, the object is a type collection, wherein the single expression can provide initialization of the collection.

5. The system of claim 1, further comprising a compiler that implements the single expression.

6. The system of claim 1, further comprising a collection component that allows the single expression to construct and initialize a collection object, wherein the object implements an interface that allows for adding elements to the collection and the argument expressions are added to a collection.

7. The system of claim 1, the single expression is nested within data received.

8. The system of claim 6, the collection object satisfies a pattern that allows for adding elements to the collection.

9. The system of claim 1, further comprising a projection component that infers at least one of a property and a field name related to the object to be constructed and initialized.

10. The system of claim 1, further comprising an expression component allows an invocation expression to be utilized in conjunction with the single expression.

11. The system of claim 1, further comprising a typeless component allows the omission of a new keyword and a type that is being constructed and initialized, wherein the new keyword and type is inferred.

12. The system of claim 1, further comprising an anonymous component that provides the object that is an anonymous type to be inferred in relation to the single expression.

13. The system of claim 1, further comprising an ordinal component that utilizes an ordinal base and ordinal assignment in a collection based on an unidentified target type.

14. The system of claim 1, further comprising an intelligent component that infers a target type in the single expression related to constructing and initializing the object.

15. The system of claim 1, the syntax component utilizing a late binding technique.

16. A computer readable medium having stored thereon the components of the system of claim 1.

17. A computer-implemented method that facilitates constructing an object, comprising:
receiving data related to a programming language;
utilizing a single syntactic construct to represent a construction and initialization of an object; and
implementing the syntax to construct and initialize the object.

18. The method of claim 17, further comprising:
utilizing a late binding associated to a target type to the syntax;
evaluating the received data; and
generating a single expression related to construction and initialization of the object.

19. A data packet that communicates between a syntax component and an interface component, the data packet facilitates the method of claim 17.

20. A computer-implemented system that facilitates constructing an object, comprising:
means for receiving data related to an object that has at least one property associated therewith; and
means for combining a construction of the object and an initialization of the at least one property into a single expression.
